(19) United States
(12) Patent Application Publication
(10) Pub. No.: US 2014/0287394 A1
(43) Pub. Date: Sep. 25, 2014

(54) SYSTEM, METHOD, AND APPARATUS FOR ASSISTING IN THE DEVELOPMENT OF GOOD ORAL HYGIENE HABITS AMONG YOUNG CHILDREN

(71) Applicant: My Pet Flag, LLC, Marlton, NJ (US)

(72) Inventor: Linette Bond, Marlton, CA (US)

(73) Assignee: My Pet Flag, LLC, Marlton, NJ (US)

(21) Appl. No.: 14/222,505

(22) Filed: Mar. 21, 2014

Related U.S. Application Data
(60) Provisional application No. 61/804,118, filed on Mar. 21, 2013.

(51) Int. Cl. G09B 19/00; G09B 5/06

(52) U.S. Cl. CPC G09B 19/0084; G09B 5/065
USPC 434/263

(57) ABSTRACT

Brushing systems include a base configured to assist in keeping the system in an upright position. The base is coupled to a stand being sized, shaped, and positioned so as to couple the base and a support structure. The support structure is configured to provide support for a audio/video device positioned thereon, the audio/video device being configured to provide an audio/visual presentation to a child while brushing his or her teeth, the audio/visual presentation including information on proper oral hygiene habits.

### RELATED APPLICATION

This application is a NON-PROVISIONAL of U.S. Provisional Patent Application No. 61/804,118, filed Mar. 21, 2013, which is incorporated herein by reference.

### FIELD OF INVENTION

The present invention relates to a system, method, and apparatus for assisting children in the development of good oral hygiene habits.

### BACKGROUND

Young children often suffer from poor oral hygiene because of a lack of understanding as to how to properly brush their teeth. Additionally, young children are typically not motivated to brush their teeth properly for a recommended time period.

### SUMMARY

Exemplary audio/video devices may include a video display screen enabled to provide a visual presentation to a child while brushing his or her teeth, the visual presentation including information on proper oral hygiene habits, a speaker enabled to provide an audio presentation to a child while brushing his or her teeth, the audio presentation including information on proper oral hygiene habits and corresponding to the video presentation, a user interface configured to enable a user to interface with the audio/video device, and a power source configured to provide electrical power to the audio/video device.

Exemplary systems consistent with the invention may include a base configured to assist in keeping the system in an upright position, the base being coupled to a stand, the stand being sized, shaped, and positioned so as to couple the base and a support structure, the support structure, the support structure being configured to provide for support for a audio/video device positioned thereon, and the audio/video device, the audio/video device being configured to provide an audio/visual presentation to a child while brushing his or her teeth, the audio/visual presentation including information on proper oral hygiene habits.

Exemplary methods described herein may include receiving, by a brushing system, an activation instruction and initiating presentation of an audio/visual presentation including information on proper oral hygiene habits responsively to the activation instruction.

### BRIEF DESCRIPTION OF THE DRAWINGS

The present application is illustrated by way of example, and not limitation, in the figures of the accompanying drawings, in which:

FIG. 1 is a block diagram illustrating an exemplary system, in accordance with some embodiments of the present invention;

FIG. 2 is a block diagram illustrating an exemplary audio/visual device, in accordance with some embodiments of the present invention;

FIG. 3 is a diagram illustrating an exemplary brushing system, in accordance with some embodiments of the present invention; and

FIG. 4 is flow chart depicting exemplary process, in accordance with some embodiments of the present invention.

Throughout the drawings, the same reference numerals and characters, unless otherwise stated, are used to denote like features, elements, components, or portions of the illustrated embodiments.

### DESCRIPTION

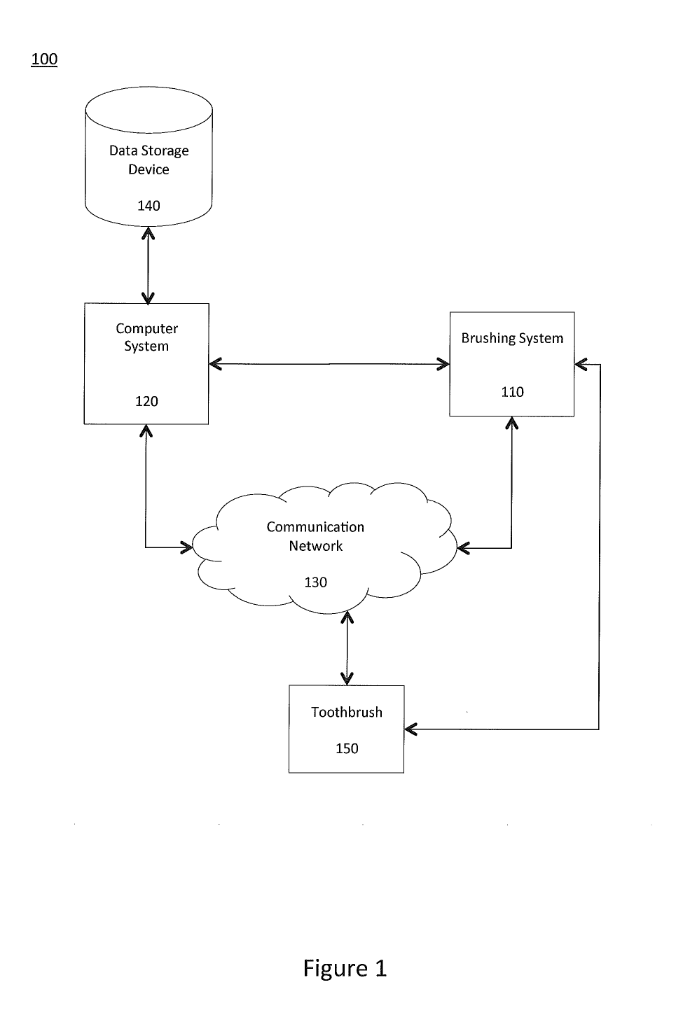

A system, method, and apparatus for the development of good oral hygiene habits among young children is herein disclosed. The system may include an apparatus as depicted in FIG. 1 configured to provide one or more instructional audio-visual presentations regarding good oral hygiene habits to a user, typically a child between the ages of 2 and 10 years of ages. All or a portion of the system may be resident within, for example, a dedicated device (as is depicted in FIG. 1), a combination of devices (e.g., television and DVD player), and/or a computerized device (e.g., laptop computer, smart phone, tablet computer, etc. When the apparatus is resident within a dedicated device, the dedicated device may include a processor enabled to provide the audio-visual presentation to the user and a memory upon which to store the audio-visual presentation. The dedicated device may also include a user interface (e.g., touch screen or buttons) via which a user and/or a parent/guardian of a user may enter data such as brushing duration, time or date. The memory may be enabled to store such entries and the processor may be enabled to process such entries.

When the apparatus is not resident within a dedicated device, the instructional audio-visual presentation may be provided to the apparatus via any available means including, but not limited to, optical media, magnetic media, a DVD, a Blu-ray, and/or a video clip provided via a network (e.g., the Internet).

The video portion of the presentation may include, for example, filmed photographic images and/or hand- or computer-drawn images, stop-action animation, or full animation, and/or written instructions or feedback to help children learn good oral hygiene habits. The audio portion of the presentation may include music, songs, or spoken words that offer, for example, instruction, encouragement, and/or feedback to children as they exercise good oral hygiene. Often times the audio and video portions of the presentation may be integrated together so that the audio and video events of the presentation correspond to one another in a meaningful way.

In some embodiments, the system may also include one or more tools (e.g., a toothbrush, dental floss, toothpaste, mouthwash, etc.) useful in the execution of good oral hygiene. In other embodiments, the user may supply one or more of these tools. When the tool(s) are included and/or associated with the system, the tool(s) and the apparatus may be integrated together so as to assist in the development of good oral hygiene. For example, a system may include a toothbrush configured to provide audio or visual feedback (e.g., beeps or flashing lights) to a user in conjunction with observing the audio-visual display. Likewise, the apparatus may be configured to provide feedback (e.g., cheers or flashing lights) to a user in conjunction with his or her use of the tool. For example, a toothbrush may include a motion sensor that detects the motion of the toothbrush and this information may be transmitted to a processor for analysis to determine whether the motion is associated with proper brushing habits. The processor may then instruct a feedback mechanism resident within the toothbrush and/or apparatus to provide feedback responsively to the analysis of the movement.

The In some embodiments, the audio-visual presentation may be timed to shut off when a desired time for exercising good oral hygiene habits has expired (e.g., 1 or two minutes) and in some embodiments, this period of time may be user configurable so that a user, or a parent/guardian of a user, may set a time period during which the user is to exercise good oral hygiene.

In some embodiments, the invention may include a reward system or gaming component whereby users are rewarded for practicing good oral hygiene habits. For example, a user may enter the number of times a week or day he or she brushes and/or flosses his or her teeth or uses fluoride enhanced mouthwash and may receive a reward for doing so.

In one embodiment, one or more components of the system may be included within a software application downloadable to, for example, a computer, a mobile computing device (e.g., laptop or tablet computer) or a smart phone. The software application may enable the device upon which it is executing (or a remote device assisting in the operation) to receive user feedback regarding use of the software application and analyze this feedback. In some cases, rewards or other incentives may be offered to the user based upon the received feedback and/or analysis thereof. The software application may include one or more games designed to, for example, provide instructions regarding good oral hygiene or provide rewards for the use of good oral hygiene.

On some occasions, the apparatus and/or system may be adapted according to one or more user characteristics such as gender, age, or preference. For example, some apparatus or systems may be configured in a particular set of colors (e.g., pink for girls, white or blue for boys) or shapes (e.g., fairies for girls and sporting equipment for boys) according to a user gender or preference. The apparatus may also include various branding mechanisms, such as cartoon characters or celebrity endorsements.

Turning now to FIG. 1, which depicts a system 100 for assisting in the development of good oral hygiene habits among young children. The components of system 100 may be communicatively coupled to one another via, for example, a direct connection and/or a connection via a communication network 130. Communication network 130 may be any network enabling communication between any of the components included within system 100 via the World Wide Web, such as the Internet.

Computer system 120 may be any computer system enabled to communicate with brushing system 110 including, but not limited to, a personal computer, a tablet computer, and a computer enabled your indication device (e.g., a smart phone). In some instances, computer system 120 may be a server or internet-enabled Web server.

Brushing system 110 may communicate with brushing system 110 may communicate with computer system 120 in order to; for example, download sets of instructions and/or audio/visual presentations that may be stored in computer system 120 and/or data storage device 140. Brushing system 110 may be enabled to communicate with toothbrush 150 via a wired or wireless communication connection. Communication between toothbrush 150 and brushing system 110 may include information regarding when and how toothbrush 150 is used including a time period of use.

Brushing system 110 may also upload information regarding its operation and/or an operation of toothbrush 150 to computer system 120 for storage in, for example, data storage device 140.

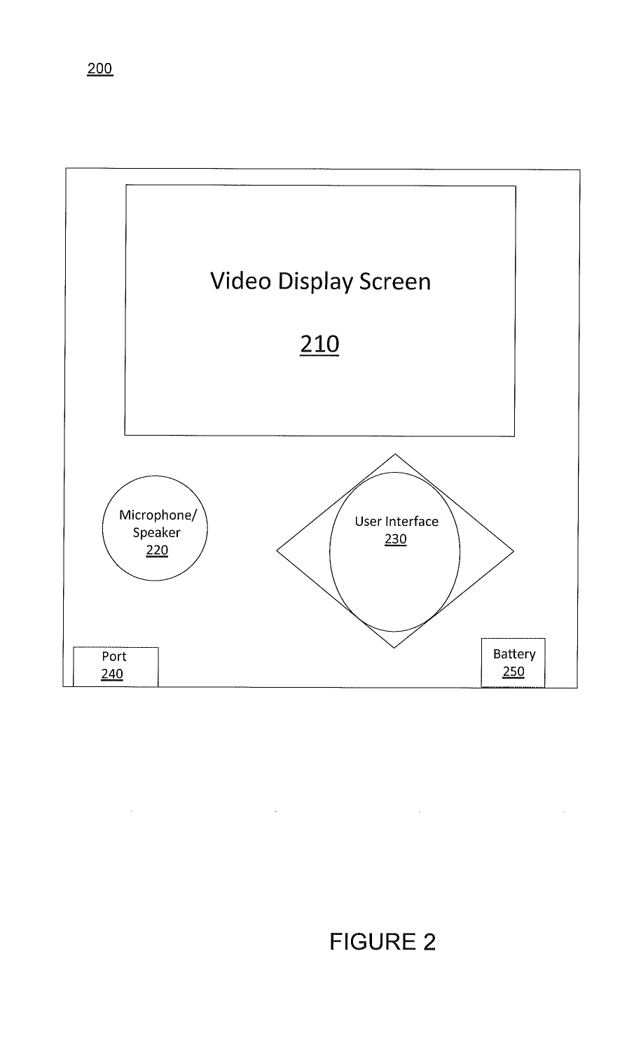

FIG. 2 is a block diagram depicting an exemplary audio/video device 200. Audio/video device 200 maybe any appropriate device enabled to provide an audio and/or visual presentation to a child while brushing his or her teeth. Content of the audio/visual presentation will be directed to the development of good oral hygiene habits and may include, for example, tips on proper tooth brushing technique, games designed to encourage good oral hygiene habits, and/or messages designed to encourage and motivate children to properly and regularly brush their teeth.

Audio/visual device 200 may include a video display screen 210, a microphone and/or speaker 220, a user interface 230, a port 240, and a power source/battery 250. The components of audio/visual device 200 may be communicatively and/or electrically coupled via any known means including, but not limited to, a communications bus. Operation of one or more of the components of system 200 may be controlled by a processor (not shown) enabled to receive communication from one or more components of audio/visual device 200, provide information to a user responsively to the communication, and/or execute instructions to enable the operation of audio/visual device 200 and/or system 100.

Video display screen 210 may be any screen enabled to provide a visual display to a child while brushing his or her teeth (e.g., LCD or liquid crystal) and, in some instances, may be touch screen enabled. Microphone/speaker 220 may be enabled to provide an audio signal to a child while brushing his or her teeth. In some instances, microphone/speaker 220 may be enabled to receive and record an audio signal from, for example, a child using the brushing system 100 and/or a parent, guardian, or friend who records a message on a memory device (not shown) for later playback to the child using brushing system 100.

Audio/video device 200 may be enabled to receive and/or transmit information via port 240. For example, audio/visual device 200 may receive an audiovisual presentation from computer system 120, transmit usage information to computer system 120, and/or receive information from and associated toothbrush, such as toothbrush 150. In some instances, port 240 may be wirelessly enabled.

User interface 230 may be any device that enables a user to interact with audio/visual device 200. Exemplary user interfaces 230 include a button or series of navigational arrows, which when activated, control the operation of audio/visual device 200 and/or brushing system 110.

Audio/video device 200 may be powered by, for example, a battery 250 resident within audio/video device 200. The battery may be disposable or rechargeable. Recharging of the battery may be facilitated by a battery charger acting via port 240. Additionally, or alternatively, audio/visual device 200 may be powered directly via port 240 without the use of batter 250.

Optionally, the audio/visual presentation may be timed so as to coincide with a recommended length of time (e.g., 1 minutes or 2 minutes) for brushing the teeth so that a child using the brushing system is prompted to stop brushing when the audio/visual display concludes.

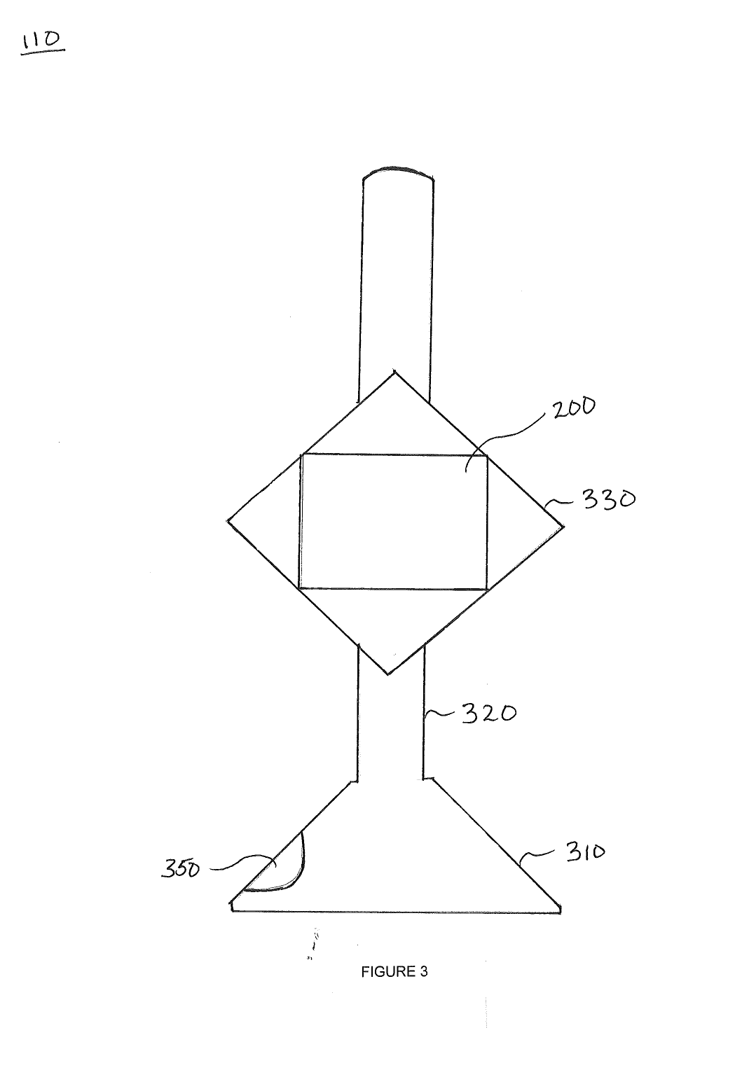

An exemplary brushing system 110 is depicted in FIG. 3. Brushing system 110 includes a base 310 coupled to a stand 320 for a support structure 330 that supports a audio/video device 200 positioned thereon. Base 310 may serve to, for example, assist in keeping brushing system 110 in an upright position by, for example, having a weight sufficient to position a center of gravity for the brushing system 110 closer to a surface upon which brushing system rests. Base 310 may also be sized and shaped so as to assist in keeping brushing system 110 in an upright position and may thereby prevent a tipping over of brushing system 110 into a horizontal, or substantially horizontal, position.

Stand 320 may be any size and shape sufficient to couple base 310 to support structure 330. Support structure 330 may be sized and positioned so as to support audio/video device 200 position thereon. Support structure 330 may support audio/video device 200 via, for example, exerting a force upon audio/video device 200 in a direction opposite to a gravitational force acting upon audio/video 200 via, for example, a shelf or other support structure. Additionally, or alternatively, support structure 330 may support a audio/video device 200 via a coupling of audio/video device 200 to support structure 330 via any known means (e.g., glue, epoxy, Velcro, clips, snaps, or some combination thereof).

Optionally, base 310 may include a holder 350 for a toothbrush. In some embodiments, holder 350 may be an opening or hole in base 310 sized and positioned so as to support a toothbrush (not shown) in a substantially vertical position when inserted therein. In some embodiments, an upper portion of a toothbrush inserted in holder 350 may be supported by (e.g., rest upon) a portion of support structure 330.

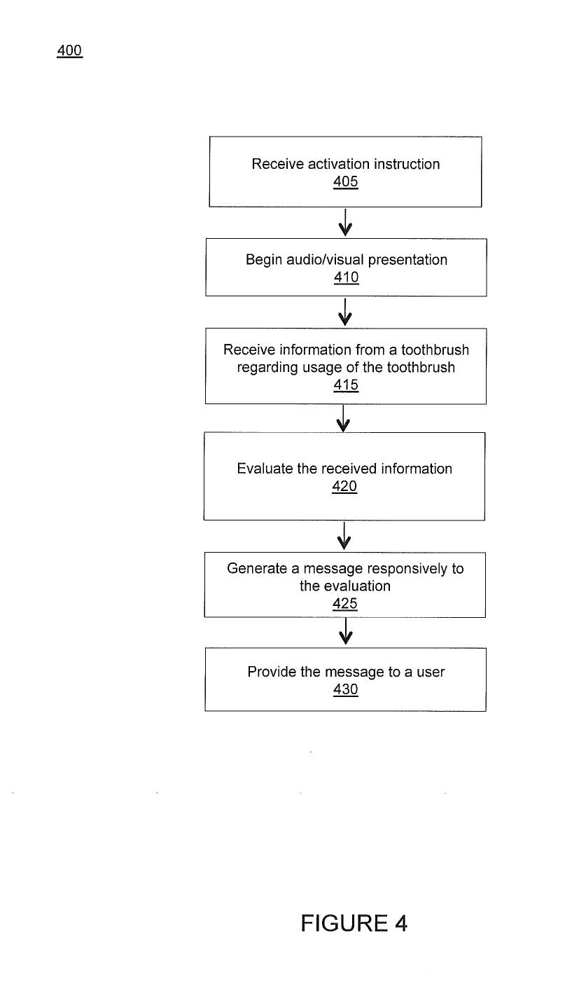

FIG. 4 is a flowchart depicting an exemplary process 400 for using a brushing system, such as brushing system 110. Process 400 may be executed by system 100 and/or any component included therein.

Initially, and activation instruction may be received (step 405). Exemplary activation instructions include removal of a toothbrush from holder 350 or activation of user interface 230. In some embodiments, the activation instruction may be via a voice signal received by microphone/speaker 220. An audio/visual presentation may then be initiated responsively to the activation instruction (step 410).

Optionally, information regarding usage of a toothbrush and/or brushing system 110 may be received from they toothbrush, such as toothbrush 150 (step 415). The received information may then be evaluated (step 420) to determine, for example, whether the information is consistent with good oral hygiene habits. A message may be generated responsively to the evaluation (step 425) and provided to the user (step 430). In some instances, the received information, evaluation results, and/or message may be stored on a memory within brushing system 110 and/or may be communicated to a computer system, such as computer system 120.

Hence, a system, method, and apparatus for assisting children in the development of good oral hygiene habits has been herein described.

I claim:

1. An audio/video device comprising:
a video display screen enabled to provide a visual presentation to a child while brushing his or her teeth, the visual presentation including information on proper oral hygiene habits;
a speaker enabled to provide an audio presentation to a child while brushing his or her teeth, the audio presentation including information on proper oral hygiene habits and corresponding to the video presentation;
a user interface configured to enable a user to interface with the audio/video device; and
a power source configured to provide electrical power to the audio/video device.

2. A system comprising:
a base configured to assist in keeping the system in an upright position, the base being coupled to a stand;
the stand being sized, shaped, and positioned so as to couple the base and a support structure;
the support structure, the support structure being configured to provide for support for a audio/video device positioned thereon; and
the audio/video device, the audio/video device being configured to provide an audio/visual presentation to a child while brushing his or her teeth, the audio/visual presentation including information on proper oral hygiene habits.

3. A method comprising:
receiving, by a brushing system, an activation instruction; and
initiating, by the brushing system, presentation of an audio/visual presentation including information on proper oral hygiene habits responsively to the activation instruction.
